(19) United States
(12) Patent Application Publication
(10) Pub. No.: US 2023/0046813 A1
(43) Pub. Date: Feb. 16, 2023

(54) SELECTING COMMUNICATION SCHEMES BASED ON MACHINE LEARNING MODEL PREDICTIONS

(71) Applicant: Capital One Services, LLC, McLean, VA (US)

(72) Inventors: Abdelkader M'Hamed BENKREIRA, Brooklyn, NY (US); Joshua EDWARDS, Philadelphia, PA (US); Michael MOSSOBA, Great Falls, VA (US)

(21) Appl. No.: 17/445,152

(22) Filed: Aug. 16, 2021

(51) Int. Cl. H04W 12/06; H04W 8/18; G06Q 40/02; G06N 20/00

(52) U.S. Cl. CPC H04W 12/06; H04W 8/18; G06Q 40/02; G06N 20/00

(57) ABSTRACT

In some implementations, a prediction and monitoring system may processing, using a machine learning model, account data associated with an account that is associated with a user of a user device to identify a series of recurring events associated with the user device. The prediction and monitoring system may generate, using the machine learning model, a predicted transaction date and a predicted transaction amount that are both associated with the series of recurring events. The prediction and monitoring system may select, based on additional account data associated with the account and at least one of the predicted transaction date or the predicted transaction amount, a particular communication scheme, of a plurality of communication schemes, for communicating with the user. The prediction and monitoring system may transmit at least one message according to the particular communication scheme to facilitate authentication of the user.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for selecting communication schemes based on machine learning model predictions. The system may include one or more memories and one or more processors communicatively coupled to the one or more memories. The one or more processors may be configured to identify an account associated with a user of a user device. The one or more processors may be configured to identify, based on account data associated with the account and using a machine learning model, a series of recurring events associated with the user device. The one or more processors may be configured to generate, using the machine learning model, a predicted transaction date and a predicted transaction amount that are both associated with the series of recurring events. The one or more processors may be configured to determine, based on additional account data associated with the account and at least one of the predicted transaction date or the predicted transaction amount, an estimated status of the user device. The one or more processors may be configured to select, based on the estimated status of the user device, a particular communication scheme, of a plurality of communication schemes, for communicating with the user. The one or more processors may be configured to receive, after determining the particular communication scheme, a request for the user to access a resource. The one or more processors may be configured to transmit, based on the request, at least one message according to the particular communication scheme to facilitate authentication of the user.

Some implementations described herein relate to a non-transitory computer-readable medium that stores a set of instructions for a device. The set of instructions, when executed by one or more processors of the device, may cause the device to generate, using a machine learning model, a predicted transaction date and a predicted transaction amount that are both associated with a series of recurring events that are associated with a user device. The set of instructions, when executed by one or more processors of the device, may cause the device to select, based on account data associated with an account and at least one of the predicted transaction date or the predicted transaction amount, a particular communication scheme, of a plurality of communication schemes, for communicating with a user of the user device. The set of instructions, when executed by one or more processors of the device, may cause the device to receive, after determining the particular communication scheme, a request for the user to access a resource. The set of instructions, when executed by one or more processors of the device, may cause the device to transmit, based on the request, at least one message according to the particular communication scheme to facilitate authentication of the user.

Some implementations described herein relate to a method for selecting communication schemes based on machine learning model predictions. The method may include processing, by a device and using a machine learning model, account data associated with an account that is associated with a user of a user device to identify a series of recurring events associated with the user device. The method may include generating, by the device and using the machine learning model, a predicted transaction date and a predicted transaction amount that are both associated with the series of recurring events. The method may include selecting, by the device and based on additional account data associated with the account and at least one of the predicted transaction date or the predicted transaction amount, a particular communication scheme, of a plurality of communication schemes, for communicating with the user. The method may include transmitting, by the device, at least one message according to the particular communication scheme to facilitate authentication of the user.

### BRIEF DESCRIPTION OF THE DRAWINGS

FIGS. 1A-1F are diagrams of an example implementation relating to selecting communication schemes based on machine learning model predictions.

FIG. 2 is a diagram illustrating an example of training and using a machine learning model in connection with selecting communication schemes.

FIG. 3 is a diagram of an example environment in which systems and/or methods described herein may be implemented.

FIG. 4 is a diagram of example components of one or more devices of FIG. 3.

FIG. 5 is a flowchart of an example process relating to selecting communication schemes based on machine learning model predictions.

### DETAILED DESCRIPTION

The following detailed description of example implementations refers to the accompanying drawings. The same reference numbers in different drawings may identify the same or similar elements.

In a typical multi-factor authentication (MFA) scheme, a user of a first user device inputs, into the first user device, a request for the user to access a resource, which sends the request to an MFA server. The MFA server provides an MFA challenge form, requesting a security code, to the first user device (e.g., for presentation to the user) and provides a message that includes a security code, which is to be input into the MFA challenge form, to a second user device of the user (e.g., for presentation to the user). The user, upon viewing the message on the second user device and obtaining the security code, inputs the security code in the MFA challenge form, and submits the MFA challenge form to the MFA server device. The MFA server device validates the security code and grants the user (e.g., via the first user device) access to the resource when the security code is validated.

In many cases, the second user device is associated with an entity (e.g., a company, an organization, or an institution, among other examples) that provides the second user device to the user and/or provides a communication service for the second user device (e.g., a “data” service plan or, an Internet service plan, among other examples). Accordingly, the user may have a contractual relationship with the entity and may make regular payments to the entity (e.g., pay bills issued by the entity) from an account (e.g., a financial account, such as a checking account) associated with the user. However, in some cases, the user may make a late payment, miss a payment, or pay an incorrect amount, among other examples, which may cause the entity to inactivate the second user device (e.g., cause the second user device to be unable to receive and/or display messages).

Consequently, in these cases, the second user device cannot receive and/or display a message from an MFA server, as described above. The MFA server, therefore, wastes computing resources (e.g., processing resources, memory resources, communication resources, and/or power resources, among other examples) by generating and sending messages to the second user device that are not received and/or displayed by the second user device. Further, when the user submits, via the first user device, one or more additional requests for the user to access the resource (e.g., because the message from the MFA server was not delivered to and/or not displayed by the second user device), the MFA server, in some cases, determines (incorrectly) that the one or more additional requests are fraudulent attempts to access the resource. This affects an accuracy of a fraud detection algorithm utilized by the MFA server, causes the MFA server to lock access to the resource, and/or causes the MFA server to perform additional authentication techniques to verify the user, among other examples, which further waste computing resources.

Some implementations described herein provide a prediction and monitoring system that processes, using a machine learning model, account data associated with an account of a user of a user device to identify a series of events associated with the user device, such as series of regular or semi-regular bill payments for a service associated with the user device. The prediction and monitoring system may generate, based on the account data and using the machine learning model, predicted information that indicates a predicted transaction amount and/or a predicted transaction date of a predicted event associated with the series of events (e.g., a next bill payment).

The prediction and monitoring system then may determine, based on additional account data associated with the account (e.g., newly added account data) an estimated status of the user device. For example, when the prediction and monitoring system determines that a transaction amount associated with a current event of the series of recurring events is greater than or equal to the predicted transaction amount and/or that the current event occurred within a threshold number of days after the predicted transaction date (e.g., which may indicate that a bill has been fully and/or timely paid), the prediction and monitoring system may determine that the user device has an active estimated status (e.g., the user device is able to receive and/or display messages). Alternatively, when the prediction and monitoring system determines that the transaction amount associated with the current event is less than the predicted transaction amount and/or that the current event did not occur within the threshold number of days after the predicted transaction date (e.g., which may indicate that a bill has not been fully and/or timely paid), the prediction and monitoring system may determine that the user device has an inactive estimated status (e.g., the user device is unable to receive and/or display messages).

In some implementations, the prediction and monitoring system may select a communication scheme for communicating with the user based on the estimated status of the user device. For example, when the estimated status indicates that the user device is active, the prediction and monitoring system may select a particular communication scheme that facilitates communication between the prediction and monitoring system and the user device (e.g., because the user device is likely to receive and display messages sent by the prediction and monitoring system). As another example, when the estimated status indicates that the user device is inactive, the prediction and monitoring system may select a particular communication scheme that facilitates communication between the prediction and monitoring system and at least one other user device associated with the user (e.g., because the user device is unlikely to receive and display messages sent by the prediction and monitoring system).

In this way, the prediction and monitoring system selects and utilizes a communication scheme that increases a likelihood that messages sent by the prediction and monitoring system are successfully delivered to the user. Accordingly, the prediction and monitoring system conserves computing resources (e.g., processing resources, memory resources, communication resources, and/or power resources, among other examples) by preventing transmission of messages that would not otherwise be received and/or responded to by the user (e.g., because the user device is not able to receive and/or display the messages). Further, this increases a likelihood that the user responds to a message (e.g., an MFA message) sent by the prediction and monitoring system, which enables the prediction and monitoring system to authenticate access to a resource requested by the user. This reduces a likelihood that a request to access the resource is deemed to be potentially fraudulent, which increases an accuracy of fraud detection algorithms to identify actual fraudulent attempts (rather than detecting “unreceived” messages attempts). This also reduces a likelihood that the prediction and monitoring system locks access to the resource and/or performs additional authentication techniques to verify the user, which further conserves computing resources.

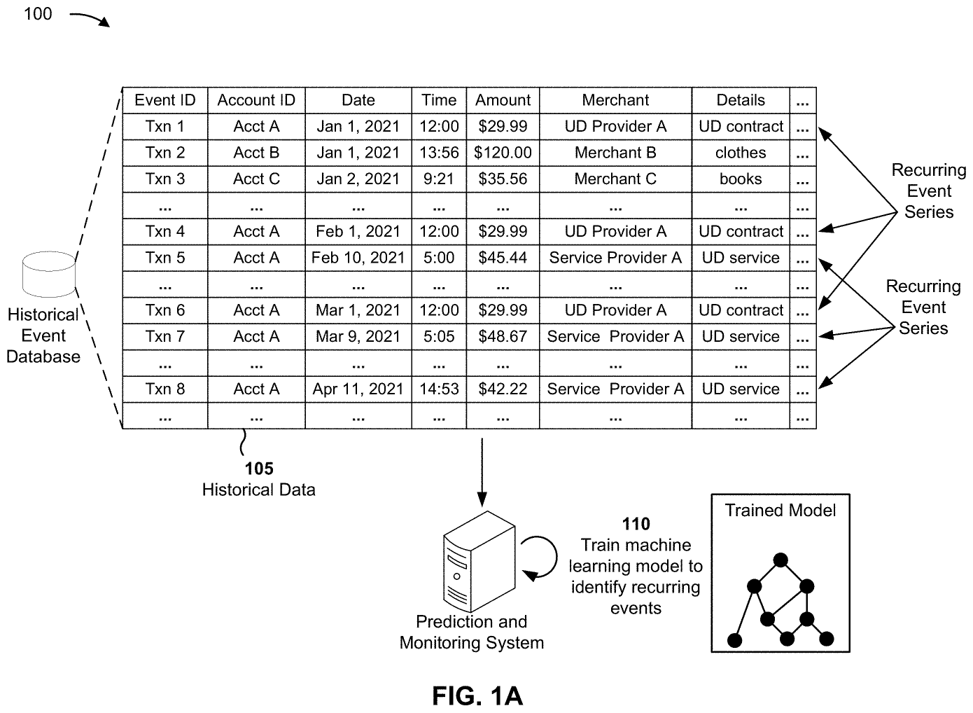

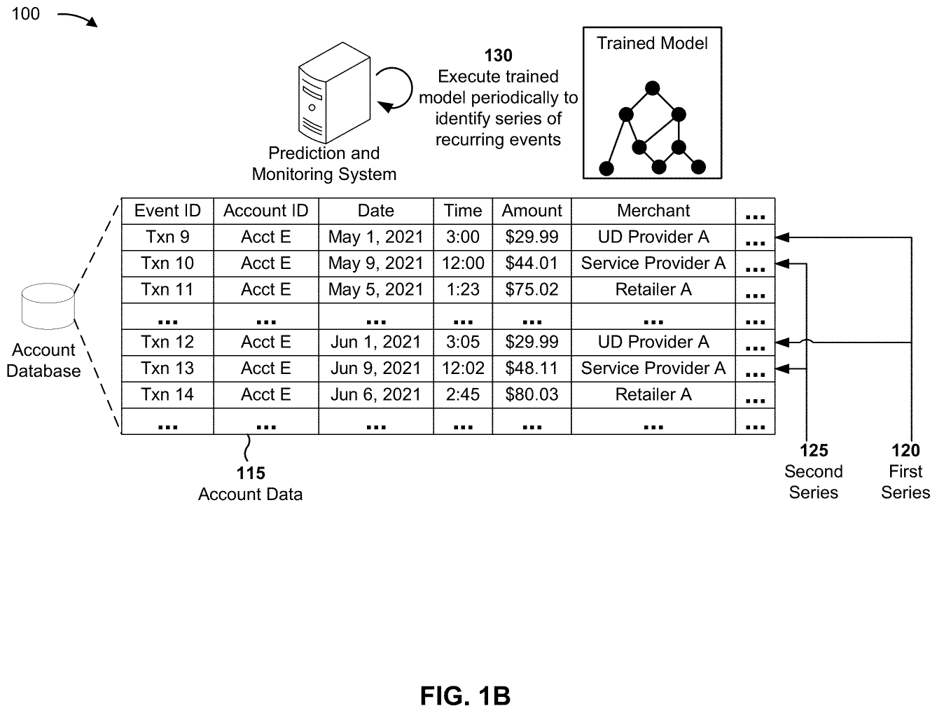

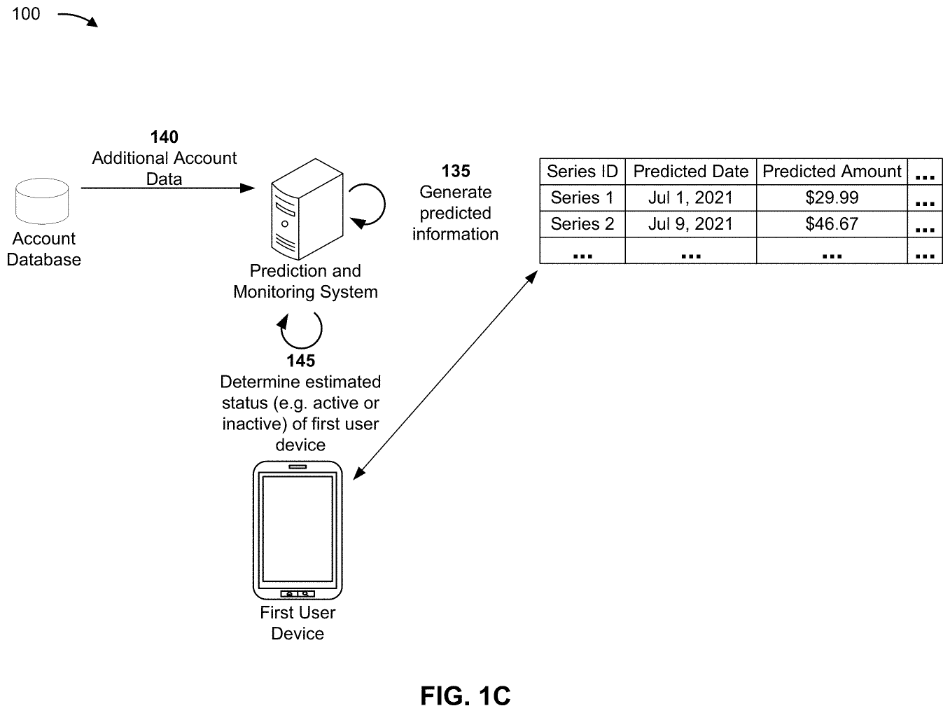

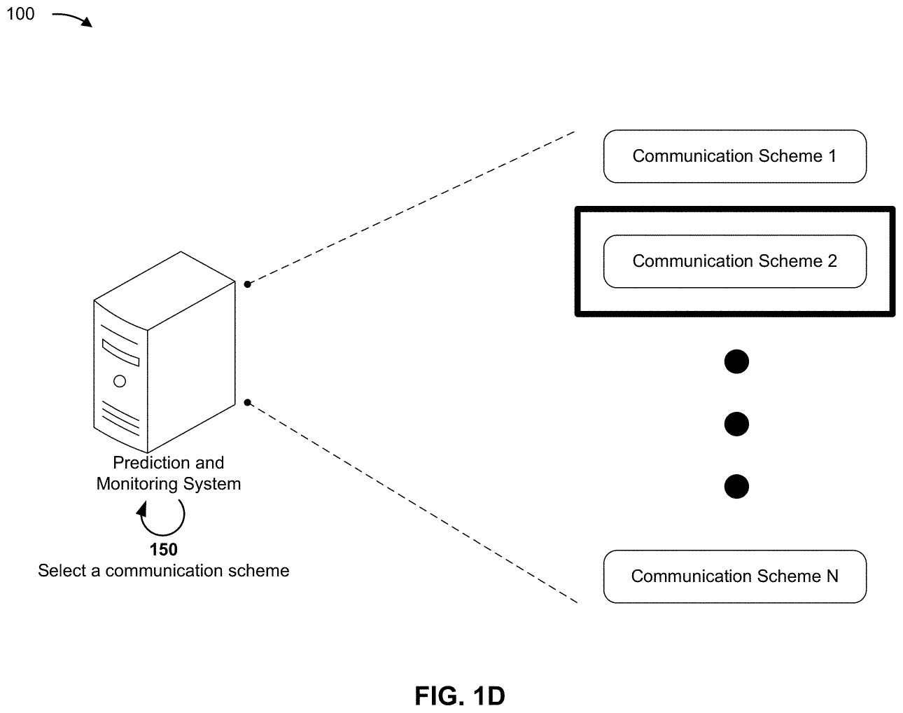

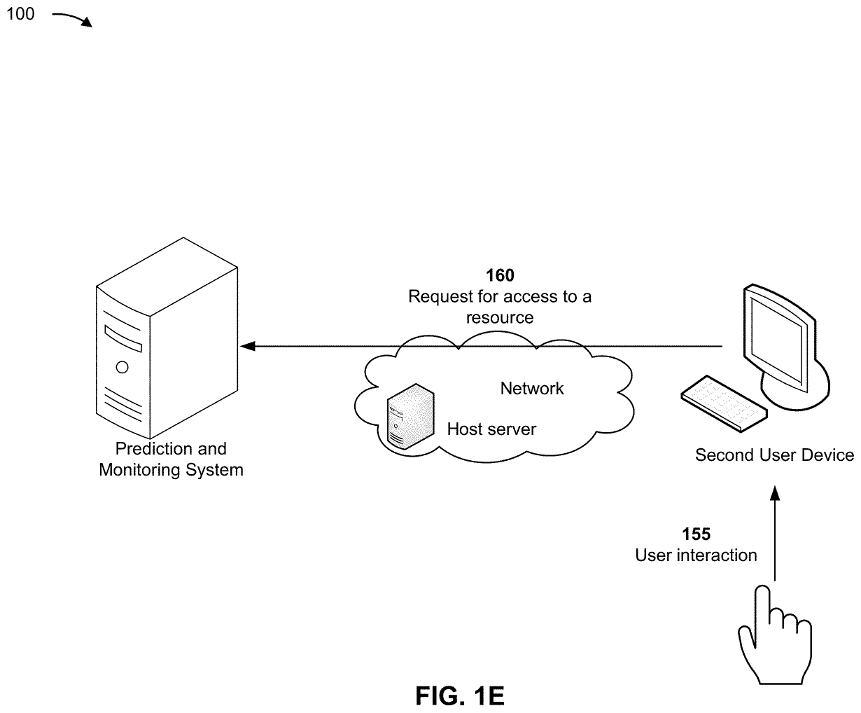

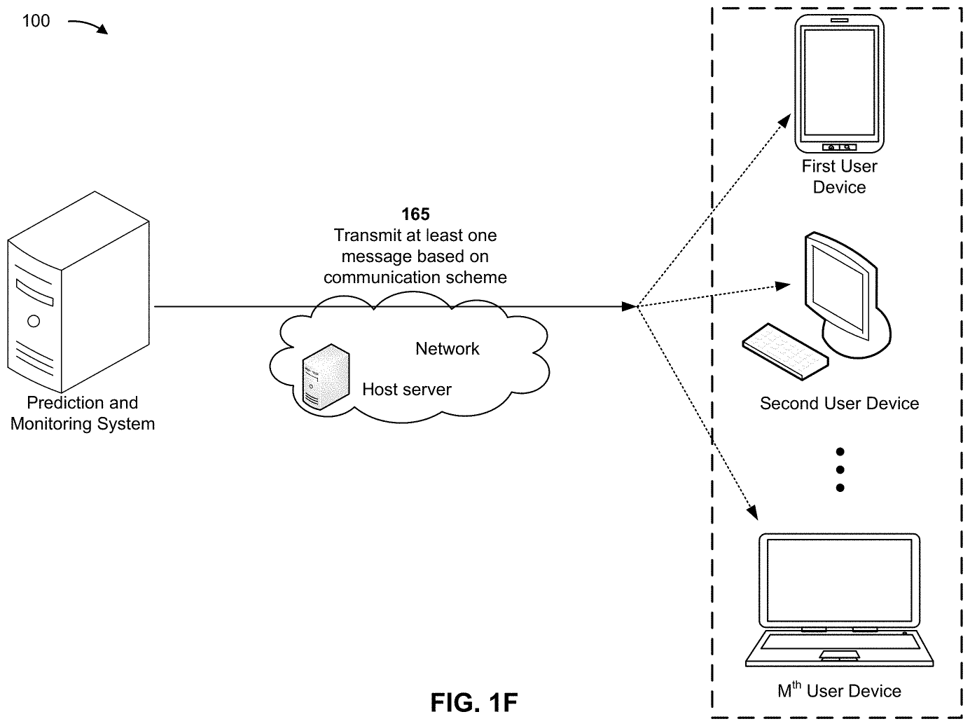

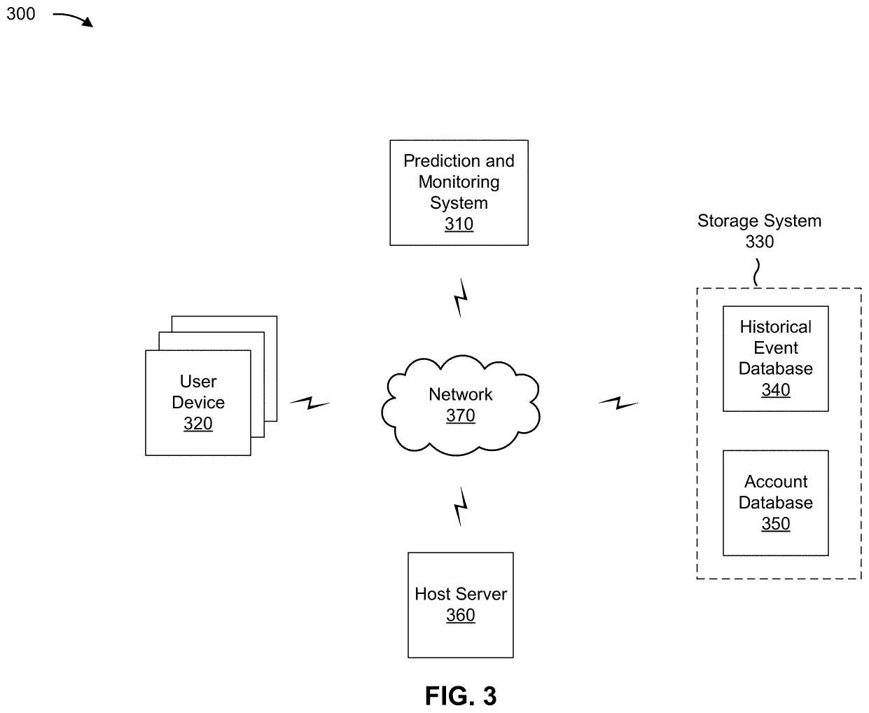

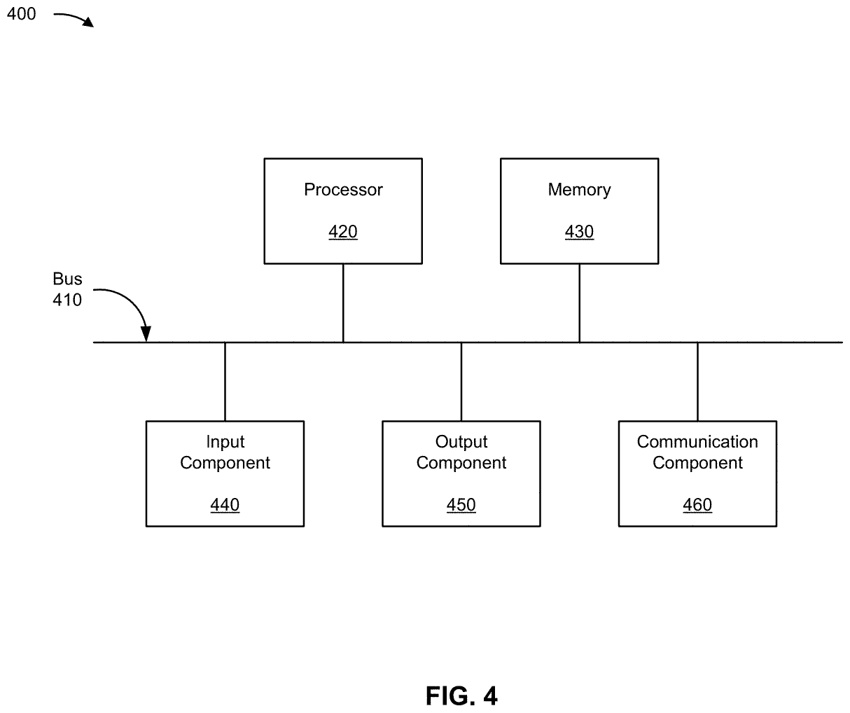

FIGS. 1A-1F are diagrams of an example 100 associated with selecting communication schemes based on machine learning model predictions. As shown in FIGS. 1A-1F, example 100 includes a prediction and monitoring system, a plurality of user devices (shown as first through M^{th} user devices, where M≥2), and a plurality of databases (e.g., a historical event database and an account database, which may be included in a storage system). These devices are described in more detail in connection with FIGS. 3 and 4.

The plurality of user devices may be associated with a single user (e.g., the plurality of user devices may be used by the user to communicate with other user devices). Each user device, of the plurality of user devices may have a different association with the user. For example, the first user device may be a frequently used user device of the user (e.g., a personal smartphone of the user), a second user device may be a semi-frequently user device of the user (e.g., a work computer of the user), a third user device may be an infrequently used user device of the user (e.g., a family-shared tablet computer), and/or so on.

As shown in FIG. 1A, the historical event database may store historical data 105. The historical data may include one or more entries respectively associated with one or more events (e.g., one or more historical events). An event may be an action that occurred at a particular time. For example, an event may be a transaction associated with an account (e.g., a financial account, such as a checking account) at a particular time. Accordingly, an entry associated with an event may include one or more details associated with the event. For example, as shown in FIG. 1A, when the event is associated with a transaction of a financial account, the entry may indicate an event identifier (e.g., a transaction identifier) (shown as Event ID), a transaction account identifier (shown as Account ID), a transaction date indicator (shown as Date), a transaction time indicator (shown as Time), a transaction amount indicator (shown as Amount), a transaction merchant identifier (shown as Merchant), and/or a transaction details indicator (shown as Details), among other examples. In this way, the historical data 105 may include entries associated with many different events.

As further shown in FIG. 1A, the historical data 105 may include one or more sets of entries respectively associated with one or more series of recurring events. A recurring event may be an event that occurred on a recurring basis (e.g., daily, weekly, monthly, semiannually, or annually, among other examples). For example, as shown in FIG. 1A, the historical data 105 may include a first set of entries associated with a first series of recurring events that are associated with an account that has a transaction account identifier of Acct A, a merchant that has a transaction merchant identifier of user device (UD) provider A, and a transaction details indicator of UD contract (e.g., entries with event identifiers Txn 1, Txn 4, and Txn 6). The UD provider A may be an entity that provides a user device to a user associated with Acct A as part of the UD contract (e.g., an installment plan or a rental plan, among other examples). The first set of entries indicate that the first series of recurring events were associated with transaction amounts of $29.99 and occurred monthly on the first of the month (e.g., on Jan. 1, 2021; Feb. 1, 2021; and Mar. 1, 2020) at the same time (e.g., 12:00 PM). As another example, as further shown in FIG. 1A, the historical data 105 may include a second set of entries associated with a second series of recurring events associated with the account that has a transaction account identifier of Acct A, a merchant that has a transaction merchant identifier of Service Provider A, and a transaction details indicator of UD service (e.g., entries with event identifiers Txn 5, Txn 7, and Txn 8). The Service Provider A may be an entity that provides a communication service for the user device as part of the UD service (e.g., a “data” service plan or an Internet service plan, among other examples). The second set of entries indicate that the second series of recurring events were associated with different transaction amounts (e.g., $45.44, $48.67, and $42.22) and occurred monthly on different dates and times (e.g., on Feb. 10, 2021 at 5:00 AM; Mar. 9, 2021 at 5:05 AM; and Apr. 11, 2021 at 2:53 PM). While these examples are associated with series of recurring events that are associated with a single account (e.g., that has the account identifier of Acct A), the historical data 105 may include series of recurring events associated with multiple different accounts (e.g., that are associated with multiple different users and/or of a single user).

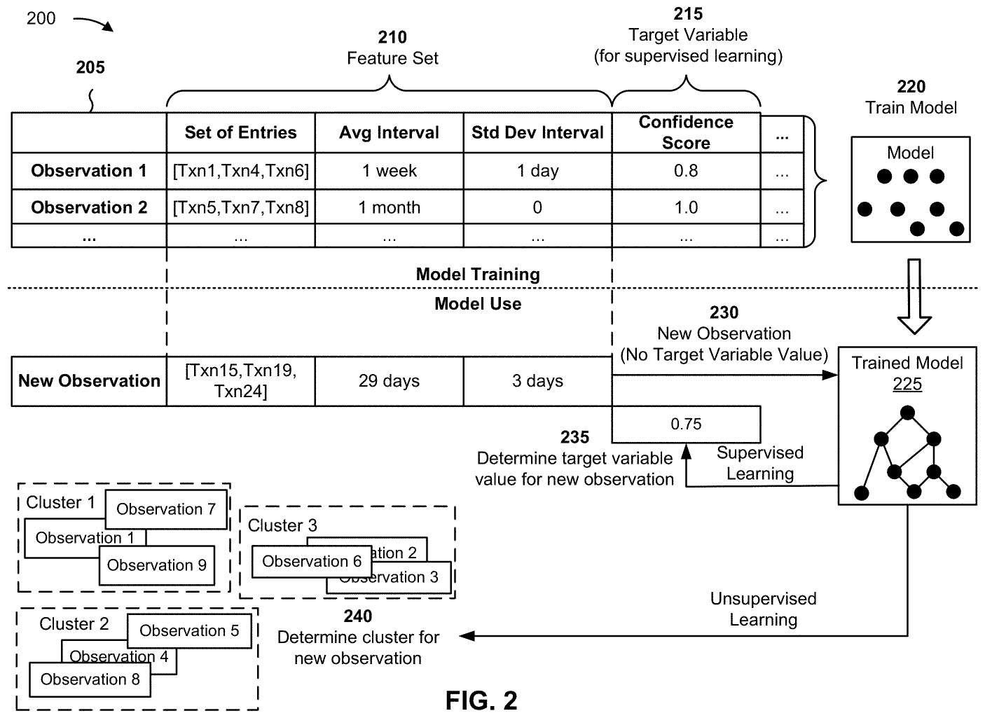

In some implementations, the prediction and monitoring system may communicate with the historical event database to access and/or to obtain the historical data 105. As further shown in FIG. 1A, and by reference number 110, the prediction and monitoring system may train a machine learning model to identify recurring events (e.g., based on the historical data 105). In some implementations, the prediction and monitoring system may train the machine learning model based on information included in the one or more entries (e.g., that are respectively associated with one or more events) of the historical data 105 and/or additional information, such as indications of sets of entries, of the one or more entries, that are respectively associated with series of recurring events; statistical information associated with the series of recurring events (e.g., an average time between events included in a series of recurring events, a standard deviation determined for times between events included in a series of recurring events, an average transaction amount associated with a series of recurring events, and/or a standard deviation determined for transaction amounts of a series of recurring events); and/or confidence scores that respectively indicate a confidence level that a set of entries is associated with a series of recurring events. Using the historical data 105 and/or the additional information as inputs to the machine learning model, the prediction and monitoring system may determine a confidence score that an entry is associated with a recurring event and/or that a set of entries is associated with a series of recurring events. Additionally, or alternatively, the prediction and monitoring system may train the machine learning model to identify a series of recurring events that are associated with a user device (e.g., a series of recurring events that are associated with an entity that provides the user device and/or that provides a communication service for the user device). In some implementations, the machine learning model may be trained and/or used in a manner similar to that described below with respect to FIG. 2.

As shown in FIG. 1B, the account database may store account data 115 associated with an account (e.g., a financial account), such as an account of a user of the first user device of the plurality of user devices. The account data 115 may include, for the account, one or more entries respectively associated with one or more events (e.g., one or more financial transactions). For example, as shown in FIG. 1B, the account data 115 may include, for an account that has a transaction account identifier of Acct E, a plurality of entries (e.g., entries with event identifiers Txn 9 through 14). In some implementations, an entry of the account data 115 may include elements that are the same as, or similar to, elements of an entry of the historical data 105 (e.g., an event identifier, a transaction account identifier, a transaction date indicator, a transaction time indicator, a transaction amount indicator, and/or a transaction merchant identifier). In some implementations, the account data 115 may include entries associated with many different events (e.g., that are associated with different merchants).

In some implementations, the account data 115 may include one or more sets of entries respectively associated with one or more series of recurring events that are associated with the first user device. For example, the account data 115 may include a first set of entries, of the plurality of entries, associated with a first series of recurring events 120 that are associated with the first user device (e.g., events that have a transaction merchant identifier of UD Provider A) and/or a second set of entries associated with a second series of recurring events 125 that are associated with the first user device (e.g., events that have a transaction merchant identifier of Service Provider A). The first set of entries (e.g., entries with event identifiers Txn 9 and Txn 12) indicate that the first series of recurring events were associated with transaction amounts of $29.99 and occurred monthly on the first of the month (e.g., on May 1, 2021 and Jun. 1, 2021) and at similar times (e.g., 3:00 AM and 3:05 AM). The second set of entries (e.g., entries with event identifiers Txn 10 and Txn 13) indicate that the second series of recurring events were associated with different transaction amounts ($44.01 and $48.11) and occurred monthly on different dates and times (e.g., on May 9, 2021 at 12:00 PM and Jun. 9, 2021 at 12:02 PM).

In some implementations, the prediction and monitoring system may communicate with the account database to access and/or to obtain the account data 115. The prediction and monitoring system may process the account data 115 to identify at least one series of recurring events that are associated with the first user device. In some implementations, as shown in FIG. 1B, and by reference number 130, the prediction and monitoring system may execute the machine learning model (e.g., that was trained as described in relation to FIG. 1A and/or FIG. 2) to identify at least one series of recurring events associated with the first user device in the account data 115. For example, the prediction and monitoring system may provide the account data 115 as input to the machine learning model and the machine learning model may identify the first set of entries that are associated with the first series of recurring events 120 that are associated with the first user device and/or the second set of entries that are associated with the second series of recurring events 125 that are associated with the first user device. In some implementations, the prediction and monitoring system may periodically (e.g., every 30 minutes, 2 hours, 12 hours, or 24 hours, among other examples) execute the machine learning model. In this way, the prediction and monitoring system may timely identify a series of recurring events that are associated with the first user device.

As shown in FIG. 1C, and by reference number 135, the prediction and monitoring system may generate predicted information for a series of recurring events that are associated with the first user device. For example, the prediction and monitoring system may generate a predicted transaction date (e.g., a prediction of a date on which a predicted event, associated with the series of recurring events, is to occur) and/or a predicted transaction amount (e.g., that is associated with the predicted event in connection with the predicted transaction date).

In some implementations, the prediction and monitoring system may provide information relating to the series of recurring events that are associated with the first user device to the machine learning model (e.g., that was trained as described in relation to FIG. 1A and/or FIG. 2 and/or that was used to identify the series of recurring events as described in relation to FIG. 1B) and may execute the machine learning model to generate the predicted transaction date and/or the predicted transaction amount. For example, the prediction and monitoring system may use the machine learning model to process the first set of entries of the account data 115 that are associated with the first series of recurring events 120 to generate a first prediction of a first predicted transaction date (e.g., Jul. 1, 2021) on which a first predicted event (e.g., a payment to UD Provider A to provide the first user device to the user), associated with the first series of recurring events 120 (Series 1), is to occur and/or a first predicted transaction amount (e.g., a transaction amount of $29.99) associated with the first predicted event. As another example, as further shown in FIG. 1C, the prediction and monitoring system may use the machine learning model to process the second set of entries of the account data 115 that are associated with the second series of recurring events 125 to generate a second prediction of a second predicted transaction date (e.g., Jul. 9, 2021) on which a second predicted event (e.g., a payment to Service Provider A to provide a communication service to the first user device), associated with the second series of recurring events 125 (Series 2), is to occur and/or a second predicted transaction amount (e.g., a transaction amount of $46.67) associated with the second predicted event.

In some implementations, the prediction and monitoring system may determine a confidence score associated with a prediction and may include the confidence score in the predicted information. For example, the machine learning model may output a confidence score that is related to a prediction (e.g., a predicted transaction date and/or a predicted transaction amount) associated with a series of recurring events. The confidence score may indicate a likelihood that the prediction is correct. For example, the confidence score may be within a range of 0 to 1 (e.g., the confidence score may be greater than or equal to 0 and less than or equal to 1), where a confidence score greater than or equal to 0.7 indicates that the prediction is highly likely (e.g., a percentage chance that the prediction is correct is greater than or equal to a first threshold percentage, such as 90%), a confidence score less than 0.7 and greater than or equal to 0.5 indicates that the prediction is likely (e.g., the percentage chance that the prediction is correct is greater than or equal to a second threshold percentage, such as 70%, and less than the first threshold percentage), a confidence score less than 0.5 and greater than or equal to 0.4 indicates that the prediction is possible (e.g., the percentage chance that the prediction is correct is greater than or equal to a third threshold percentage, such as 50%, and less than the second threshold percentage), a confidence score less than 0.4 and greater than or equal to 0.2 indicates that the prediction is unlikely (e.g., the percentage chance that the prediction is correct is greater than or equal to a fourth threshold percentage, such as 30%, and less than the third threshold percentage), and a confidence score less than 0.2 indicates that the prediction is highly unlikely (e.g., the percentage chance that the prediction is correct is greater than or equal to a fifth threshold percentage, such as 10%, and less than the fourth threshold percentage).

As further shown in FIG. 1C, the prediction and monitoring system may communicate with the account database to access and/or to obtain additional account data 140. The additional account data 140 may include, for the account, one or more additional entries respectively associate with one or more additional events (e.g., one or more events that have occurred since the prediction and monitoring system obtained the account data 115 and/or the prediction and monitoring system generated the predicted information). An entry of the additional account data 140 may include elements that are the same as, or similar to, elements of an entry of the account data 115 (e.g., an event identifier, a transaction account identifier, a transaction date indicator, a transaction time indicator, a transaction amount indicator, and/or a transaction merchant identifier).

As shown by reference number 145, the prediction and monitoring system may determine an estimated status of the first user device (e.g., based on the prediction information and/or the additional account data 140). The estimated status of the first user device may indicate, for example, that the first user device is active (e.g., the first user device is operable and/or able to receive messages) or inactive (e.g., the first user device is inoperable and/or unable to receive messages).

For example, the prediction and monitoring system may identify a current date (e.g., a date that the prediction and monitoring system is determining the estimated status of the first user device). The prediction and monitoring system may determine that the current date is before, or the same date as, the predicted transaction date. The prediction and monitoring system therefore may determine that the first user device has an active estimated status (e.g., because a bill associated with an entity providing the first user device and/or a communication service for the user device is likely not yet due).

Alternatively, the prediction and monitoring system may determine that the current date is after the predicted transaction date. The prediction and monitoring system may determine whether a difference in a number of days between the predicted transaction date and the current date is greater than or equal to a threshold number of days (e.g., a particular number of days, such as 5 days, 15 days, or 30 days, among other examples). When the prediction and monitoring system determines that the difference is less than the threshold number of days, the prediction and monitoring system may determine that the first user device has an active estimated status (e.g., because a grace period to pay a bill associated with an entity providing the first user device and/or a communication service for the user device has likely not yet expired). Alternatively, when the prediction and monitoring system determines that the difference is greater than or equal to the threshold number of days, the prediction and monitoring system may determine that a current event associated with the series of recurring event did not occur (e.g., by processing the additional account data 140 with the machine learning model described herein). Accordingly, the prediction and monitoring system may determine that the first user device has an inactive estimated status (e.g., because a grace period to pay a bill associated with an entity providing the first user device and/or a communication service for the user device has likely expired).

In another example, the prediction and monitoring system may identify, based on the additional account data 140, a transaction amount associated with a current event of the series of recurring events (e.g., by processing the additional account data 140 with the machine learning model described herein to identify the current event). The prediction and monitoring system may compare the transaction amount associated with the current event and the predicted transaction amount. When the prediction and monitoring system determines that the transaction amount associated with the current event is greater than or equal to the predicted transaction amount, the prediction and monitoring system may determine that the first user device has an active estimated status (e.g., because a bill associated with an entity providing the first user device and/or a communication service for the user device has likely been fully paid).

Alternatively, when the prediction and monitoring system determines that the transaction amount associated with the current event is less than the predicted transaction amount, the prediction and monitoring system may determine whether a difference between the predicted transaction amount and the transaction amount associated with the current event is greater than or equal to a transaction difference threshold (e.g., a particular percentage of the predicted transaction amount, such as 15%). When the prediction and monitoring system determines that the difference is greater than or equal to the difference transaction threshold (e.g., which may indicate that transaction amount associated with the current event is likely sufficient to pay a partial bill to maintain operation of the first user device) the prediction and monitoring system may determine that the first user device has an active estimated status. Alternatively, when the prediction and monitoring system determines that the difference is less than the difference transaction threshold (e.g., which may indicate that transaction amount associated with the current event is likely insufficient to pay a partial bill to maintain operation of the first user device) the prediction and monitoring system may determine that the first user device has an inactive estimated status.

In an additional example, the prediction and monitoring system may identify, based on the additional account data 140, a current event associated with the series of recurring events (e.g., by processing the additional account data 140 with the machine learning model described herein to identify the current event). The prediction and monitoring system may determine that the current event occurred within a threshold number of days after the predicted transaction date (e.g., a particular number of days, such as 5 days, 15 days, or 30 days, among other examples). Accordingly, the prediction and monitoring system may determine whether a transaction amount of the current event is greater than or equal to a threshold percentage of the predicted transaction amount (e.g., a particular percentage of the predicted transaction amount, such as 65% of the predicted transaction amount). When the prediction and monitoring system determines that the transaction amount of the current event is greater than or equal to the threshold percentage of the predicted transaction amount (e.g., which may indicate that transaction amount associated with the current event is likely sufficient to partially pay a bill to maintain operation of the first user device) the prediction and monitoring system may determine that the first user device has an active estimated status. Alternatively, when the prediction and monitoring system determines that the transaction amount of the current event is less than the threshold percentage of the predicted transaction amount (e.g., which may indicate that transaction amount associated with the current event is likely insufficient to partially pay a bill to maintain operation of the first user device) the prediction and monitoring system may determine that the first user device has an inactive estimated status.

As shown in FIG. 1D, and by reference number 150, the prediction and monitoring system may select (e.g., based on the estimated status of the first user device) a communication scheme, from a plurality of communication schemes (e.g., shown as communication schemes 1 through N, where N≥2, in FIG. 1D), for communicating with the user of the first user device (e.g., the single user associated with the first through M^{th} user devices). Each communication scheme, of the plurality of communication schemes, may identify a set of communication methods (e.g., one or more communication methods) to be attempted when transmitting a message (e.g., to communicate with the user). A set of communication methods may include, for example, a mobile application messaging communication (e.g., a “push” notification messaging communication), a text messaging communication (e.g., a short message service (SMS) messaging communication or another text messaging communication), an e-mail communication, and/or a phone call communication (e.g., a voice or audible communication). Additionally, or alternatively, the communication scheme may identify at least one user device, of the plurality of user devices, as a message transmission destination for each communication method of the set of communication methods. For example, the communication scheme may indicate that the first user device is a message transmission destination for the mobile application messaging communication, that the second user device is a message transmission destination for the text messaging communication and/or the phone call communication, and so on.

In some implementations, each communication scheme, of the plurality of communication schemes, may be different than at least one other communication scheme of the plurality of communication schemes (e.g., communication scheme 1 may be different than at least of communication schemes 2 through N). For example, a particular communication scheme may identify a first set of communication methods to be attempted and another communication scheme may identify a second set of communication methods to be attempted, wherein the first set is different than the second set.

In some implementations, the prediction and monitoring system may select a particular communication scheme, from the plurality of communication schemes, based on the estimated status of the first user device (e.g., as determined by the prediction and monitoring system, as described herein in relation to FIG. 1C and reference number 145). For example, when the estimated status of the first user device indicates that the user device is active, the prediction and monitoring system may select a particular communication scheme that facilitates communication between the prediction and monitoring system and the first user device (e.g., a communication scheme that indicates the first user device as a message transmission destination). As another example, when the estimated status of the first user device indicates that the user device is inactive, the prediction and monitoring system may select a particular communication scheme that facilitates communication between the prediction and monitoring system and at least one other user device of the plurality of user device (e.g., a communication scheme that indicates at least one of the second through M^{th} user devices as a message transmission destination).

The prediction and monitoring system may use the selected communication scheme to communicate with the user of the first user device (e.g., the user associated with the first through M^{th} user devices). For example, when the selected communication scheme facilitates communication between the prediction and monitoring system and the first user device, the prediction and monitoring system may transmit at least one message to the first user device via at least one of a mobile application messaging communication, a text messaging communication, an e-mail communication, or a phone call communication (e.g., because the first user device is likely to be active and is therefore able to receive and display the at least one message). As an alternative example, when the selected communication scheme facilitates communication between the prediction and monitoring system and the at least one other user device (e.g., at least one of the second through M^{th} user devices), the prediction and monitoring system may transmit at least one message to the at least one other user device via at least one of a mobile application messaging communication, a text messaging communication, an e-mail communication, or a phone call communication (e.g., because the first user device is likely to be inactive and is therefore unable to receive and display the at least one message). Additional details related to transmitting at least one message according to the selected communication scheme is described herein in relation to FIG. 1F and reference number 165.

As shown in FIG. 1E, and by reference number 155, the user of the first user device (e.g., the user associated with the first through M^{th} user devices) may interact with a user interface of the second user device (e.g., a keyboard and/or display screen of the second user device). The user may interact with the user interface to navigate the user interface and/or to input information into the second user device. For example, the user may interact with the user interface of the second user device to perform an unlock operation to allow the user to access a home screen of the second user device, an application of the second user device, and/or a hardware resource of the second user device (e.g., a hard drive, a camera, and/or a microphone of the second user device). As another example, the user may interact with the user interface of the second user device to perform an application initiation operation to cause an application to run on the second user device and/or to cause the application to access a network resource (e.g., that is hosted by the host server). In another example, the user may interact with the user interface of the second user device to perform a webpage load operation to cause a web browser of the second user device to load a webpage and/or to access a network resource (e.g., that is hosted by the host server).

Accordingly, as part of interacting with the user interface of the second user device, the user may enter a request (e.g., an MFA request) for the user to access a resource, such as a software resource (e.g., an application and/or a computer program of the second user device), a hardware resource (e.g., a hard drive, a camera, and/or a microphone associated with the second user device), and/or a network resource (e.g., information hosted by the host server, such as information associated with a social media account, an email account, a financial account, and/or a streaming multimedia account), among other examples. The request may include identification information related to the user. For example, as part of an unlock operation, the user may enter identification information that includes a passcode associated with the user and/or one or more biometric parameters associated with the user into a prompt displayed by the second user device as part of a request for access to the home screen of the second user device, to an application of the second user device, and/or to a hardware component of the second user device. The passcode may include a numerical string, a text string, and/or a personal identification number (PIN), among other examples. The one or more biometric parameters may include a fingerprint scan, an iris scan, a voice scan, and/or a face scan, among other examples, that are obtained by at least one biometric sensor of the second user device. As another example, as part of an application initiation operation, the user may enter identification information that includes a username and a password associated with the user and/or one or more biometric parameters associated with the user into a prompt displayed by the second user device to request access to initiate an application on the second user device. In an additional example, as part of a webpage load operation, the user may enter identification information that include a username and a password associated with the user into a webpage prompt displayed by a web browser of the second user device to request access to load a webpage on the web browser of the second user device.

As further shown in FIG. 1E, and by reference number 160, the second user device may transmit the request for the user to access the resource to the prediction and monitoring system (e.g., based on the user inputting the request, as described above). For example, the second user device may send the request to a host server of a network, which may send the request to the prediction and monitoring system.

As shown in FIG. 1F, and by reference number 165, the prediction and monitoring system may transmit (e.g., based on the request) at least one message according to a particular communication scheme (e.g., that was selected by the prediction and monitoring system, as described herein in relation to FIG. 1D and reference number 150). The prediction and monitoring system may transmit the at least one message to facilitate authentication of the user (e.g., to allow the user access to the requested resource). For example, the at least one message may include authentication data (e.g., a security code or security information) that the user is to enter into a prompt of the second user device (e.g., that is displayed by the second user device based on the second user device sending the request to the prediction and monitoring system) to authenticate the request as originating from the user.

In some implementations, the prediction and monitoring system may transmit the at least one message to one or more of the plurality of user devices (e.g., one or more of the first through M^{th} user devices). For example, when the selected communication scheme is a communication scheme that facilitates communication between the prediction and monitoring system and the first user device, the prediction and monitoring system may transmit at least one message to the first user device via at least one of a mobile application messaging communication, a text messaging communication, an e-mail communication, or a phone call communication (e.g., because the first user device is likely to be active and is therefore able to receive and display the at least one message). As an alternative example, when the selected communication scheme is a communication scheme that facilitates communication between the prediction and monitoring system and the at least one other user device, the prediction and monitoring system may transmit at least one message to the at least one other user device via at least one of a mobile application messaging communication, a text messaging communication, an e-mail communication, or a phone call communication (e.g., because the first user device is likely to be inactive and is therefore unable to receive and display the at least one message).

After transmitting the at least one message, the prediction and monitoring system may receive a response. For example, a user device of the plurality of user devices (e.g., one of the first through M^{th} user devices) may receive and display the at least one message on a display of the user device. The user may view the at least one message and may enter the authentication data that was included in the at least one message into the prompt of the second user device. The second user device may include the authentication data in the response and may transmit (e.g., in a similar manner as that elsewhere described herein) the response to the prediction and monitoring system.

The prediction and monitoring system may process (e.g., parse) the response to determine whether the response includes the authentication data and may cause access to the resource to be granted or denied based on determining whether the response includes the authentication data. For example, when the prediction and monitoring system determines that the response includes the authentication data, the prediction and monitoring system may cause access to the resource to be granted (e.g., by sending a grant access message to the host server and/or the second user device). As an alternative example, when the prediction and monitoring system determines that the response does not include the authentication data, the prediction and monitoring system may cause access to the resource to be denied (e.g., by sending a deny access message to the host server and/or the second user device).

As indicated above, FIGS. 1A-1F are provided as an example. Other examples may differ from what is described with regard to FIGS. 1A-1F.

FIG. 2 is a diagram illustrating an example 200 of training and using a machine learning model in connection with selecting communication schemes. The machine learning model training and usage described herein may be performed using a machine learning system. The machine learning system may include or may be included in a computing device, a server, a cloud computing environment, or the like, such as the prediction and monitoring system, the plurality of user devices, and/or the host server described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the historical event database (e.g., that is included in the storage system), as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the historical event database. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a set of entries (e.g., that are associated with a series of recurring events), a second feature of an average interval of time (e.g., between events included in the series of recurring events), a third feature of a standard deviation of the average interval time, and so on. As shown, for a first observation, the first feature may have a value of [Txn1, Txn4, Txn6], the second feature may have a value of 1 week, the third feature may have a value of 1 day, and so on. These features and feature values are provided as examples, and may differ in other examples. For example, the feature set may include one or more of the following features: an average transaction amount associated with the series of recurring events, a standard deviation for the average transaction amount, and/or other statistical information associated with the series of recurring events.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a confidence score (e.g., that indicates that the set of entries is associated with a series of recurring events), which has a value of 0.8 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of [Txn15, Txn19, Txn 24], a second feature of 29 days, a third feature of 3 days, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 0.75 for the target variable of a confidence score for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first automated action may include, for example, determining an estimated status of a user device associated with the new observation.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a highly likely prediction), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to determining whether a set of entries is associated with a series of recurring events. The machine learning system enables recognition and/or identification of tens, hundreds, thousands, or millions of features and/or feature values for tens, hundreds, thousands, or millions of observations, thereby increasing accuracy and consistency and reducing delay associated with determining whether a set of entries is associated with a series of recurring events relative to requiring computing resources to be allocated for tens, hundreds, or thousands of operators to manually determining whether a set of entries is associated with a series of recurring events using the features or feature values. While some implementations described herein in relation to FIG. 2 are directed to determining whether a set of entries is associated with a series of recurring events, the description provided herein in relation to FIG. 2 applies to training and applying a machine learning model to identify a series of recurring events that are associated with a user device and/or to generate predicted information (e.g., that includes a predicted transaction date and/or a predicted transaction amount of a predicted event associated with a series of recurring events that are associated with a user device), as described herein in relation to FIGS. 1A-1F.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a prediction and monitoring system 310, a plurality of user devices 320, a storage system 330 (e.g., that includes a historical event database 340 and an account database 350), a host server 360, and a network 370. Devices of environment 300 may interconnect via wired connections, wireless connections, or a combination of wired and wireless connections.

The prediction and monitoring system 310 includes one or more devices capable of receiving, generating, storing, processing, and/or providing information associated with selecting communication schemes based on machine learning model predictions, as described elsewhere herein. The prediction and monitoring system 310 may include a communication device and/or a computing device. For example, the prediction and monitoring system 310 may include a server, an application server, a client server, a web server, a database server, a host server, a proxy server, a virtual server (e. g., executing on computing hardware), a device that includes computing hardware used in a cloud computing environment, or a similar type of device. The prediction and monitoring system 310 may communicate with one or more other devices of environment 300, as described elsewhere herein.

The user device 320 includes one or more devices capable of receiving, generating, storing, processing, and/or providing information associated with selecting communication schemes based on machine learning model predictions, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 320 may communicate with one or more other devices of environment 300, as described elsewhere herein.

The storage system 330 includes one or more devices capable of receiving, generating, storing, processing, and/or providing information associated with selecting communication schemes based on machine learning model predictions, as described elsewhere herein. The storage system 330 may include a communication device and/or a computing device. For example, the storage system 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the storage system 330 may include the historical event database 340 and/or the account database 350. The storage system 330 may communicate with one or more other devices of environment 300, as described elsewhere herein.

The host server 360 includes one or more devices capable of receiving, generating, storing, processing, providing, and/or routing information associated with selecting communication schemes based on machine learning model predictions, as described elsewhere herein. The host server 360 may include a communication device and/or a computing device, such as a server device. For example, the host server 360 may include a server, such as an application server, a web server, a proxy server, a virtual server (e.g., executing on computing hardware), or a server in a cloud computing system. In some implementations, the host server 360 includes computing hardware used in a cloud computing environment.

The network 370 includes one or more wired and/or wireless networks. For example, the network 370 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 370 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the prediction and monitoring system 310, the user device 320, the storage system 330, and/or the host server 360. In some implementations, the prediction and monitoring system 310, the user device 320, the storage system 330, and/or the host server 360 may include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

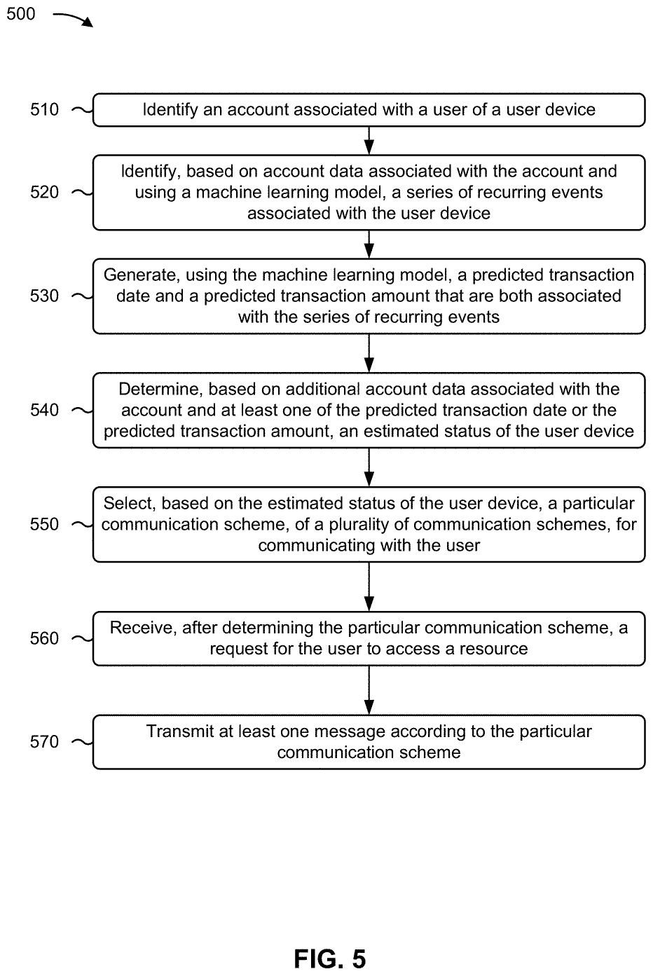

FIG. 5 is a flowchart of an example process 500 associated with selecting communication schemes based on machine learning model predictions. In some implementations, one or more process blocks of FIG. 5 may be performed by a system (e.g., prediction and monitoring system 310). In some implementations, one or more process blocks of FIG. 5 may be performed by another device or a group of devices separate from or including the system, such as a user device (e.g., user device 320) and/or a host server (e.g., host server 360). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include identifying an account associated with a user of a user device (block 510). As further shown in FIG. 5, process 500 may include identifying, based on account data associated with the account and using a machine learning model, a series of recurring events associated with the user device (block 520). As further shown in FIG. 5, process 500 may include generating, using the machine learning model, a predicted transaction date and a predicted transaction amount that are both associated with the series of recurring events (block 530). As further shown in FIG. 5, process 500 may include determining, based on additional account data associated with the account and at least one of the predicted transaction date or the predicted transaction amount, an estimated status of the user device (block 540). As further shown in FIG. 5, process 500 may include selecting, based on the estimated status of the user device, a particular communication scheme, of a plurality of communication schemes, for communicating with the user (block 550). As further shown in FIG. 5, process 500 may include receiving, after determining the particular communication scheme, a request for the user to access a resource. In some implementations, the request includes identification information related to the user (block 560). As further shown in FIG. 5, process 500 may include transmitting at least one message according to the particular communication scheme (block 570). In some implementations, the at least one message is transmitted based on the request and/or to facilitate authentication of the user.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for selecting communication schemes based on machine learning model predictions, the system comprising:
one or more memories; and
one or more processors, communicatively coupled to the one or more memories, configured to:
identify an account associated with a user of a user device,
identify, based on account data associated with the account and using a machine learning model, a series of recurring events associated with the user device;
generate, using the machine learning model, a predicted transaction date and a predicted transaction amount that are both associated with the series of recurring events;
determine, based on additional account data associated with the account and at least one of the predicted transaction date or the predicted transaction amount, an estimated status of the user device;
select, based on the estimated status of the user device, a particular communication scheme, of a plurality of communication schemes, for communicating with the user;
receive, after determining the particular communication scheme, a request for the user to access a resource,
wherein the request includes identification information related to the user; and
transmit, based on the request, at least one message according to the particular communication scheme to facilitate authentication of the user.

2. The system of claim 1, wherein the machine learning model identifies the series of recurring events based on a feature set that includes at least one of:
an average time between events included in the series of recurring events,
a standard deviation determined for times between events included in the series of recurring events,
an average transaction amount associated with the series of recurring events, or
a standard deviation determined for transaction amounts of the series of recurring events.

3. The system of claim 1, wherein the one or more processors, when determining the estimated status of the user device, are configured to:
identify, based on the additional account data, a transaction amount associated with a current event of the series of recurring events;
determine that the transaction amount associated with the current event is less than the predicted transaction amount;
determine whether a difference between the predicted transaction amount and the transaction amount associated with the current event is greater than or equal to a transaction difference threshold; and
determine, based on determining that the transaction amount associated with the current event is less than the predicted transaction amount and whether the difference is greater than or equal to the transaction difference threshold, the estimated status of the user device.

4. The system of claim 1, wherein the one or more processors, when determining the estimated status of the user device, are configured to:
identify a current date;
determine that the current date is after the predicted transaction date;
determine that a difference in a number of days between the predicted transaction date and the current date is greater than or equal to a threshold number of days;
determine, based on the additional account data and determining that the difference in the number of days is greater than or equal to the threshold number of days, that a current event associated with the series of recurring events did not occur; and
determine, based on determining that the current event did not occur, the estimated status of the user device.

5. The system of claim 1, wherein the one or more processors, when determining the estimated status of the user device, are configured to:
identify, based on the additional account data, a current event associated with the series of recurring events;
determine that the current event occurred within a threshold number of days after the predicted transaction date;
determine whether a transaction amount of the current event is greater than or equal to a threshold percentage of the predicted transaction amount; and
determine, based on determining that the current event occurred within the threshold number of days after the predicted transaction date and whether the transaction amount of the current event is greater than or equal to the threshold percentage of the predicted transaction amount, the estimated status of the user device.

6. The system of claim 1, wherein the estimated status of the user device indicates that the user device is active, and
wherein the one or more processors, when selecting the particular communication scheme, are configured to:
select, based on the estimated status of the user device, a communication scheme that facilitates communication between the system and the user device as the particular communication scheme.

7. The system of claim 1, wherein the estimated status of the user device indicates that the user device is inactive, and
wherein the one or more processors, when selecting the particular communication scheme, are configured to:
select, based on the estimated status of the user device, a communication scheme that facilitates communication between the system and another user device as the particular communication scheme.

8. The system of claim 1, wherein the one or more processors, when transmitting the at least one message according to the particular communication scheme, are configured to:
transmit the at least one message via at least one of:
a mobile application messaging communication;
a text messaging communication;
an e-mail communication; or
a phone call communication.

9. The system of claim 1, wherein the one or more processors are further configured to:
receive, after transmitting the at least one message, a response;
determine whether the response includes authentication data that was included in the at least one message; and
cause access to the resource to be granted or denied based on determining whether the response includes the authentication data.

10. A non-transitory computer-readable medium storing a set of instructions, the set of instructions comprising:
one or more instructions that, when executed by one or more processors of a device, cause the device to:
generate, using a machine learning model, a predicted transaction date and a predicted transaction amount that are both associated with a series of recurring events that are associated with a user device;
select, based on account data associated with an account and at least one of the predicted transaction date or the predicted transaction amount, a particular communication scheme, of a plurality of communication schemes, for communicating with a user of the user device;
receive, after determining the particular communication scheme, a request for the user to access a resource; and
transmit, based on the request, at least one message according to the particular communication scheme to facilitate authentication of the user.

11. The non-transitory computer-readable medium of claim 10, wherein the one or more instructions, that cause the device to select the particular communication scheme, cause the device to:
determine, based on the account data and at least one of the predicted transaction date or the predicted transaction amount, an estimated status of the user device; and
select, based on the estimated status of the user device, the particular communication scheme.

12. The non-transitory computer-readable medium of claim 10, wherein the one or more instructions, that cause the device to select the particular communication scheme, cause the device to:
determine, based on the account data, whether a transaction amount associated with a current event of the series of recurring events is less than the predicted transaction amount; and
select, based on determining whether the transaction amount associated with the current event of the series of recurring events is less than the predicted transaction amount, the particular communication scheme.

13. The non-transitory computer-readable medium of claim 10, wherein the one or more instructions, that cause the device to select the particular communication scheme, cause the device to:
identify, based on the account data, a date of a current event of the series of recurring events;
determine whether the date of the current event is after the predicted transaction date; and
select, based on determining whether the date of the current event is after the predicted transaction date, the particular communication scheme.

14. The non-transitory computer-readable medium of claim 10, wherein the one or more instructions, that cause the device to select the particular communication scheme, cause the device to:
determine, based on the account data, whether a date of a current event of the series of recurring events occurred within a threshold number of days after the predicted transaction date; and
select, based on determining whether the date of the current event occurred within the threshold number of days after the predicted transaction date, the particular communication scheme.

15. The non-transitory computer-readable medium of claim 10, wherein the one or more instructions further cause the device to:
receive, after transmitting the at least one message, a response;
determine whether the response includes authentication data that was included in the at least one message; and
cause access to the resource to be granted or denied based on determining whether the response includes the authentication data.

16. A method for selecting communication schemes based on machine learning model predictions, comprising:
processing, by a device and using a machine learning model, account data associated with an account that is associated with a user of a user device to identify a series of recurring events associated with the user device;
generating, by the device and using the machine learning model, a predicted transaction date and a predicted transaction amount that are both associated with the series of recurring events;
selecting, by the device and based on additional account data associated with the account and at least one of the predicted transaction date or the predicted transaction amount, a particular communication scheme, of a plurality of communication schemes, for communicating with the user; and
transmitting, by the device, at least one message according to the particular communication scheme to facilitate authentication of the user.

17. The method of claim 16, wherein selecting the particular communication scheme comprises:
identifying, based on the additional account data, a current event associated with the series of recurring events; and
selecting the particular communication scheme based on at least one of:
comparing a date of the current event and the predicted transaction date, or
comparing a transaction amount of the current event and the predicted transaction amount.

18. The method of claim 16, wherein selecting the particular communication scheme comprises:
determining, based on the additional account data and at least one of the predicted transaction date or the predicted transaction amount, an estimated status of the user device; and
selecting, based on the estimated status of the user device, the particular communication scheme.

19. The method of claim 18, wherein the estimated status of the user device indicates that the user device is inactive, and
wherein transmitting the at least one message according to the particular communication scheme comprises:
transmitting the at least one message to another user device.

20. The method of claim 18, wherein the estimated status of the user device indicates that the user device is active, and
wherein transmitting the at least one message according to the particular communication scheme comprises:
transmitting the at least one message to the user device.
